(19) United States
(12) Patent Application Publication
(10) Pub. No.: US 2009/0108800 A1
(43) Pub. Date: Apr. 30, 2009

(54) CASE BATTERY

(76) Inventor: Steven Woud, Los Angeles, CA (US)

Correspondence Address: PARK LAW FIRM, 3255 WILSHIRE BLVD, SUITE 1110, LOS ANGELES, CA, 90010, US

(21) Appl. No.: 11/932,594

(22) Filed: Oct. 31, 2007

(51) Int. Cl. H02J 7/00

(52) U.S. Cl. 320/103

(57) ABSTRACT

A case battery for a personal digital assistant is provided. The case battery includes a holding portion and a charging portion. The holding portion holds the personal digital assistant detachably. The charging portion is disposed in the holding portion and configured to be electrically connected to the power input. The charging portion extends the usage time of the personal digital assistant. The charging portion includes an electrical power acceptor configured to accept electrical power from outside. The charging portion may further include a secondary battery, and the electrical power acceptor is configured to charge the secondary battery using an external electrical power source. The charging portion may include a primary battery and a receptacle configured to accept the primary battery.

### BACKGROUND OF THE INVENTION

The present invention relates to a case battery. More particularly, this invention relates to a case battery, which extends the usage time of a personal digital assistant with more electrical power provided in a charging portion of the case battery.

“Portable” is one of the keywords which define the era of the information technology. Computing power had been an obstacle to make the technology portable for a long time. Considering the first computer, it would be easy to understand the situation. With the advent of the transistors and integrated circuit, however, computing power can be crammed in a really small space such that locating the heart of a computer inside the computer or even on a mother board is not easy, actually challenging to a layman. Once the computing power became no problem for a portability, it has taken a very short time to recognize the hard fact that the power source of battery is a real problem, which seems to be much harder to solve than the CPU problem.

Since 1990's, portable electronic devices such as a cellular phone, PDA, etc. have become indispensable commodities to every one. It is hard to find any one who does not have a cellular phone, for example. Still, the portable electronic devices need to be charged very frequently such that the usage is critically limited.

Accordingly, a need for a case battery for a personal digital assistant or a portable personal electronic device has been present for a long time considering the expansive demands of touch and complicated cleansing in the everyday life. This invention is directed to solve these problems and satisfy the long-felt need.

### SUMMARY OF THE INVENTION

The present invention contrives to solve the disadvantages of the prior art.

An objective of the invention is to provide a case battery for a personal digital assistant.

Another object of the invention is to provide a case battery for a personal digital assistant, which can extend the usage time of the personal digital assistant.

Still another object of the invention is to provide a case battery for a personal digital assistant, which guides sounds from the speakers of the personal digital assistant unhindered.

An aspect of the invention provides a case battery for a personal digital assistant. The case battery includes a holding portion and a charging portion.

The holding portion is configured to hold the personal digital assistant detachably, and the personal digital assistant includes a battery, a power input and one or more speakers.

The charging portion is disposed in the holding portion, and the charging portion is configured to be electrically connected to the power input so as to provide electrical power to the personal digital assistant while the personal digital assistant is attached.

The charging portion is configured to extend the usage time of the personal digital assistant.

The charging portion may include an electrical power acceptor configured to accept electrical power from outside. The charging portion may further comprise a secondary battery, and the electrical power acceptor is configured to charge the secondary battery using an external electrical power source.

The charging portion may further include a primary battery and a receptacle configured to accept the primary battery.

The holding portion may include a front surface, a rear surface, and two or more grips. The personal digital assistant is disposed on the front surface. The rear surface is disposed behind the front surface. The two or more grips, each of which extending substantially perpendicularly from an edge of the front surface, are configured to hold the personal digital assistant.

The holding portion may further include a top portion and a bottom portion, and wherein the top portion is configured to provide a space through which the personal digital assistant is attached and detached. The charging portion is provided at the bottom portion of the holding portion.

The charging portion may be provided between the front surface and the rear surface. The charging portion may include one or more connectors configured to be electrically connected to the power input of the personal digital assistant.

The holding portion may include a plurality of sound exit holes configured to guide sound from the plurality of speakers of the personal digital assistant. At least one of the plurality of sound exit holes may open toward the front side of the holding portion. At least one of the plurality of sound exit holes may open toward the rear side of the holding portion.

The holding portion may further include a mechanical fastener configured to the cast battery to a part of a user's outfit. The user's outfit may include a pair of trousers, shirts, and a belt.

The mechanical fastener may include a clip and a Velcro.

The personal digital assistant may include a cellular phone, a PDA, a palmtop, and GPS.

The case battery may be embedded in a case. The case includes a bag, a sack, a cover, and a purse.

The advantages of the present invention are: (1) the case battery can extend the usage time of the personal digital assistant; and (2) the case battery can guide the sounds from the speakers of the personal digital assistant even when the personal digital assistant is installed on the case battery.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a case battery with a personal digital assistant according to an embodiment of the present invention;

FIG. 2 is a perspective view of the case of FIG. 1 without the personal digital assistant;

FIG. 3 is a top plan view of a case battery according to an embodiment of the invention;

FIG. 4 is a top plan view of a case battery according to another embodiment of the invention; and

FIG. 5 is a side view of the case battery of FIG. 4;

FIG. 6 is another side view of a case battery without a personal digital assistant and

FIG. 7 is a perspective view of a case battery with a receptacle for a primary battery.

### DETAILED DESCRIPTION EMBODIMENTS OF THE INVENTION

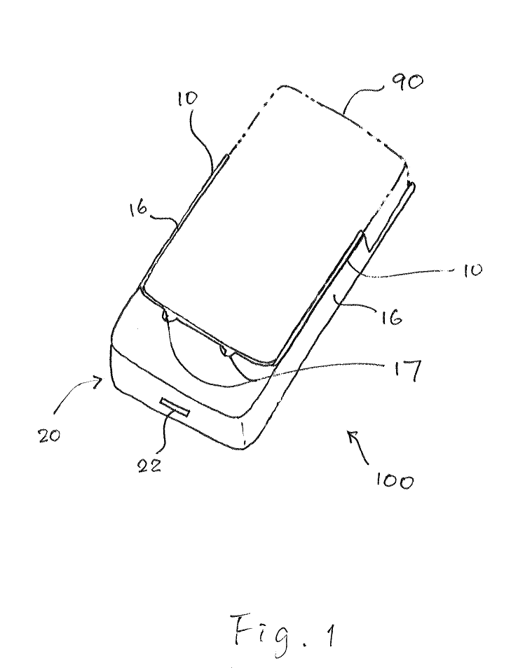

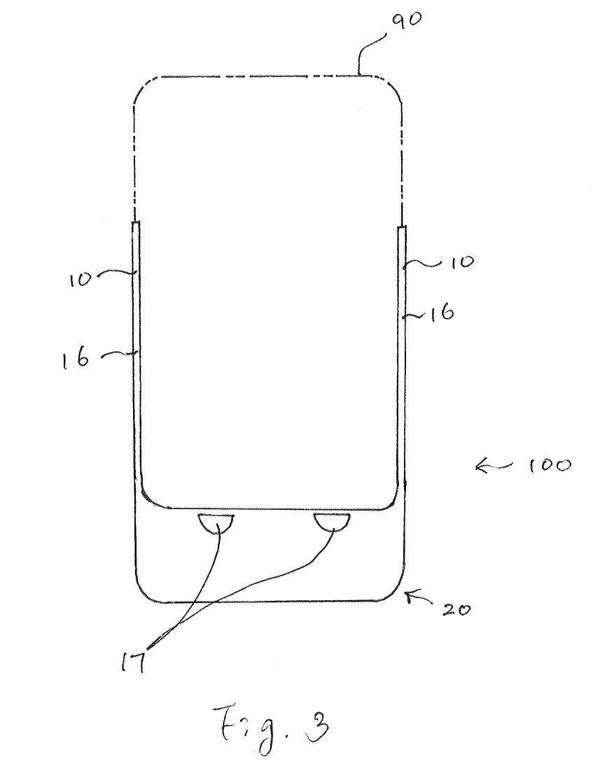

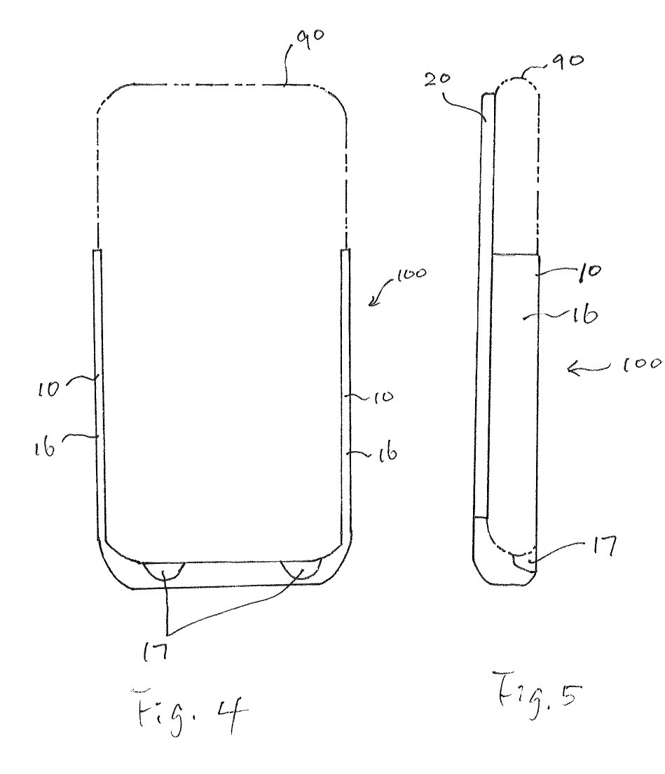

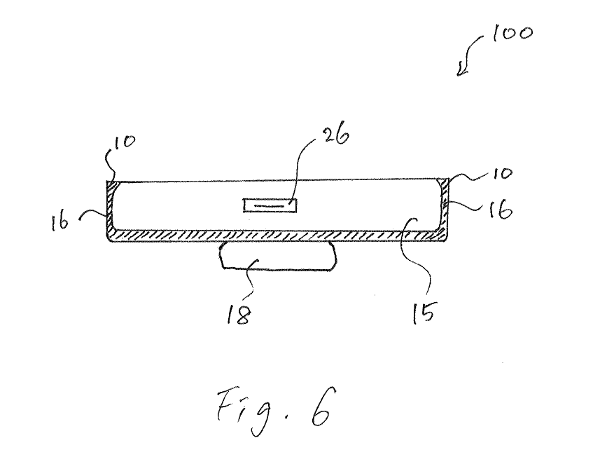

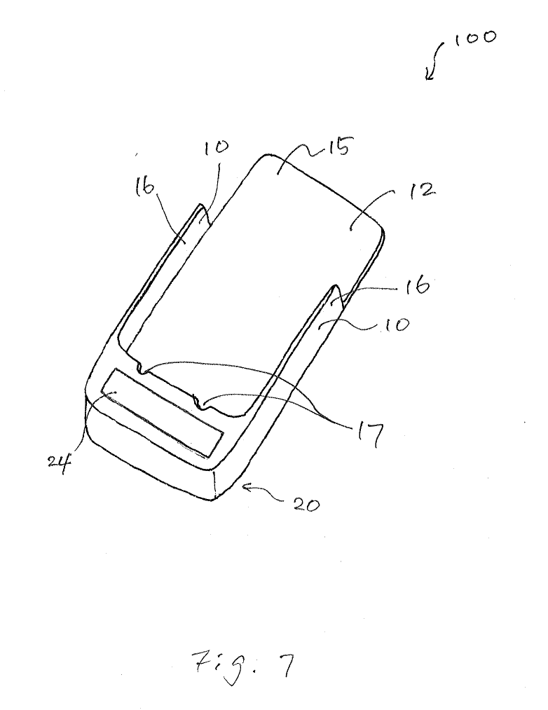

FIGS. 1-3 show a case battery 100 according to an embodiment of the present invention. FIGS. 4-5 show a case battery 100 according to another embodiment of the invention. FIG. 6 illustrates an electrical power acceptor. FIG. 7 illustrates another embodiment of the invention with a receptacle for a primary battery.

An aspect of the invention provides the case battery 100 for a personal digital assistant 90. The case battery 100 includes a holding portion 10 and a charging portion 20.

The holding portion 10 is configured to hold the personal digital assistant 90 detachably, and the personal digital assistant 90 includes a battery, a power input and one or more speakers (not shown).

The charging portion 20 is disposed in the holding portion 10, and the charging portion 20 is configured to be electrically connected to the power input of the personal digital assistant 90 so as to provide electrical power to the personal digital assistant 90 while the personal digital assistant 90 is attached.

The charging portion 20 is configured to extend the usage time of the personal digital assistant 90.

The charging portion 20 may include an electrical power acceptor 22 configured to accept electrical power from outside. The charging portion 20 may further include a secondary battery (not shown) inside, and the electrical power acceptor 22 is configured to charge the secondary battery using an external electrical power source.

The charging portion 20 may further include a primary battery (not shown) and a receptacle 24 configured to accept the primary battery as shown in FIG. 7. In the illustrated embodiment, the receptacle further includes a cover.

The holding portion 10 may include a front surface 12, a rear surface 14, and two or more grips 16. The personal digital assistant 90 is disposed on the front surface 12. The rear surface 14 is disposed behind the front surface 12. The two or more grips 16, each of which extending substantially perpendicularly from an edge of the front surface 12, are configured to hold the personal digital assistant 90.

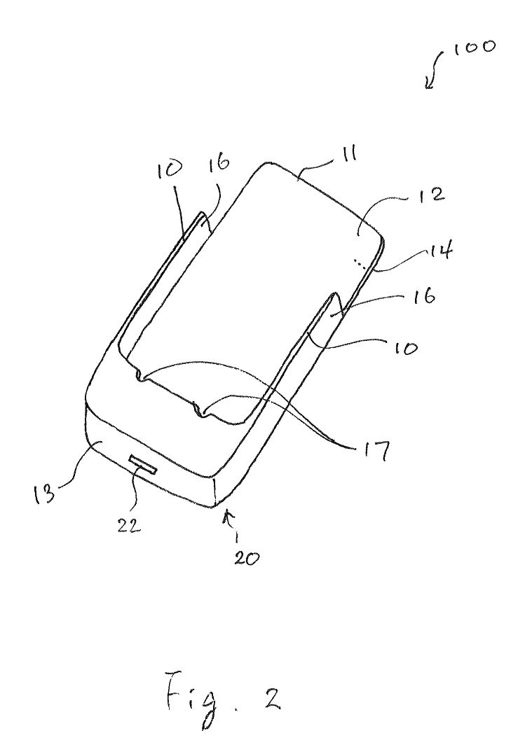

The holding portion 10 may further include a top portion 11 and a bottom portion 13 as shown in FIG. 2, and the top portion 11 is configured to provide a space 15 through which the personal digital assistant 90 is attached and detached as shown in FIGS. 6 and 7. The charging portion 20 is provided at the bottom portion 13 of the holding portion 10.

The charging portion 20 may be provided between the front surface 12 and the rear surface 14. The charging portion 20 may include one or more connectors 26 configured to be electrically connected to the power input of the personal digital assistant 90 as shown in FIG. 6. The position and shape of the one or more connectors 26 may change according to the personal digital assistant 90.

The holding portion 10 may include a plurality of sound exit holes 17 configured to guide sound from the plurality of speakers of the personal digital assistant 90. At least one of the plurality of sound exit holes 17 may open toward the front side 12 of the holding portion 10. At least one of the plurality of sound exit holes 17 may open toward the rear side 14 of the holding portion 10.

The holding portion 10 may further include a mechanical fastener 18 configured to the case battery 100 to a part of a user's outfit (not shown) as shown in FIG. 6. The user's outfit may include a pair of trousers, shirts, and a belt.

The mechanical fastener 18 may include a clip and a Velcro.

The personal digital assistant 90 may include a cellular phone, a PDA, a palmtop, and GPS.

The personal digital assistant or a cellular phone 90 can be used with the power provided by its own battery for a while. When the battery runs out, then the case battery 100 can be used as a second power. Since the charging portion 20 of the case battery 100 does not have a strict limitation of space in design as the battery in the personal digital assistant 90, the capacity of the case battery 100 can be made to extend the usage time of the personal digital assistant 90 seriously.

In certain embodiments of the invention, the case battery 100 may be embedded in a case. The case includes a bag, a sack, a cover, and a purse. The case can be small enough to carry the personal digital assistant 90 and large enough to accommodate the holding portion 10 and the charging portion 20. Also, the case may be configured to use the personal digital assistant 90 conveniently while installed in the case.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A case battery for a personal digital assistant, the case battery comprising:
a holding portion configured to hold the personal digital assistant detachably, wherein the personal digital assistant comprises a battery, a power input and one or more speakers, and
a charging portion disposed in the holding portion, the charging portion being configured to be electrically connected to the power input through a connector so as to provide electrical power to the personal digital assistant while the personal digital assistant is attached,
wherein the charging portion is configured to extend the usage time of the personal digital assistant.

2. The case battery of claim 1, wherein the charging portion comprises an electrical power acceptor configured to accept electrical power from outside.

3. The case battery of claim 2, wherein the charging portion further comprises a secondary battery, and wherein the electrical power acceptor is configured to charge the secondary battery using an external electrical power source.

4. The case battery of claim 2, wherein the charging portion further comprises a primary battery and a receptacle configured to accept the primary battery.

5. The case battery of claim 1, wherein the holding portion comprises:
a front surface on which the personal digital assistant is disposed;
a rear surface disposed behind the front surface; and
two or more grips, each of which extending substantially perpendicularly from an edge of the front surface, configured to hold the personal digital assistant.

6. The case battery of claim 5, wherein the holding portion further comprises a top portion and a bottom portion, and wherein the top portion is configured to provide a space through which the personal digital assistant is attached and detached.

7. The case battery of claim 6, wherein the charging portion is provided at the bottom portion of the holding portion.

8. The case battery of claim 4, wherein the charging portion is provided between the front surface and the rear surface.

9. The case battery of claim 8, wherein the charging portion comprises one or more connectors configured to be electrically connected to the power input of the personal digital assistant.

10. The case battery of claim 1, wherein the holding portion comprises a plurality of sound exit holes configured to guide sound from the plurality of speakers of the personal digital assistant.

11. The case battery of claim 10, wherein at least one of the plurality of sound exit holes opens toward the front side of the holding portion.

12. The case battery of claim 10, wherein at least one of the plurality of sound exit holes opens toward the rear side of the holding portion.

13. The case battery of claim 1, wherein the holding portion further comprises a mechanical fastener configured to the cast battery to a part of a user's outfit.

14. The case battery of claim 13, wherein the user's outfit comprises a pair of trousers, shirts, and a belt.

15. The case battery of claim 13, wherein the mechanical fastener comprises a clip and a Velcro.

16. The case battery of claim 1, wherein the personal digital assistant comprises a cellular phone, a PDA, a palmtop, and GPS.

17. The case battery of claim 1, wherein the case battery is embedded in a case.

18. The case battery of claim 1, wherein the case comprises a bag, a sack, a cover, and a purse.
